(19) United States
(12) Patent Application Publication
(10) Pub. No.: US 2026/0229196 A1
(43) Pub. Date: Aug. 6, 2026

(54) DISPLAY PANEL AND DRIVING METHOD THEREOF, ELECTRONIC DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Shuming CHANG, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 19/123,775

(22) PCT Filed: Oct. 16, 2024
(86) PCT No.: PCT/CN2024/125293

§ 371 Date: Apr. 24, 2025

(30) Foreign Application Priority Data
Oct. 16, 2023 (CN) 202311347963.4

(51) Int. Cl. G09G 3/36

(52) U.S. Cl. CPC G09G 3/3614; G09G 3/3607; G09G 2310/0251; G09G 2320/0242

(57) ABSTRACT

A display panel, a driving method thereof, and an electronic device are provided. The method includes: obtaining a first polarity target data voltage greater than a reference data voltage and a second polarity target data voltage smaller than a reference data voltage corresponding to a target gray scale, an absolute value of a difference between the first polarity target data voltage and the reference data voltage being not equal to an absolute value of a difference between the second polarity target data voltage and the reference data voltage, and applying the two to a same sub-pixel in a time-sharing manner or to two different sub-pixels in a time-sharing manner or in a simultaneous manner.

This application claims priority to Chinese Patent Application No. 202311347963.4 filed on Oct. 16, 2023, the entire contents of which are incorporated herein by reference.

### TECHNICAL FIELD

The present disclosure relates to the technical field of displays, and particularly relates to a display panel, a driving method thereof, and an electronic device.

### BACKGROUND

As a widely used display at present, considering the cost of a data driving chip, liquid crystal displays may adopt a three-gate driving architecture to reduce the number of data lines to ⅓ of the normal driving architecture. The number of scanning lines is increased to 3 times that of the normal driving architecture, which causes that the width and charging time of each gate pulse are also reduced to ⅓ of the normal driving architecture. In particular, when displaying a solid color image of a single color or a mixed color, the amplitude of a signal on the same data line may be always in a high-low change state. After each gate line turns on a corresponding row of pixels, the optimal charging time of each row of sub-pixels may be insufficient.

Compared with a positive polarity data signal, a data pulse e.g. negative pulse in a negative polarity data signal is closer to a trailing of a falling edge of a gate pulse e.g. a positive pulse in the gate signal, resulting in a delay in a closing time of the gate signal when the data pulse in the negative polarity data signal acts on a corresponding sub-pixel. The data voltage (greater than the negative pulse) of the next row of sub-pixels is easily mischarged to the current row of sub-pixels. In order to avoid mischarging, a phase of the gate signal is shifted forward to increase a phase difference between the corresponding gate pulse and the data voltage of the next row of sub pixels. Therefore, the optimal charging time of the current row of sub-pixels may be reduced and the phenomenon of color cast or low brightness may be further worsened.

### SUMMARY

An object of the present disclosure is to provide a display panel, a driving method thereof, and an electronic device, in order to solve the technical problem that a conventional display panel employing a three-gate driving architecture has the above-described color abnormality of an image.

In a first aspect, the present disclosure provides a driving method of a display panel, including:
obtaining a first polarity target data voltage and a second polarity target data voltage corresponding to a target gray scale, in which the first polarity target data voltage is greater than a reference data voltage, the second polarity target data voltage is smaller than the reference data voltage, and an absolute value of a difference between the first polarity target data voltage and the reference data voltage is not equal to an absolute value of a difference between the second polarity target data voltage and the reference data voltage; and
applying the first polarity target data voltage or the second polarity target data voltage to a same sub-pixel in a time-sharing manner or applying the first polarity target data voltage and the second polarity target data voltage to two different sub-pixels in a time-sharing manner or in a simultaneous manner to cause the same sub-pixel or the two different sub-pixels to emit light to exhibit a target brightness corresponding to the target gray scale.

In a second aspect, the present disclosure further provides a display panel, including:
a plurality of sub-pixels; and
a plurality of data lines, in which each of the data lines is connected to corresponding ones of the plurality of sub-pixels to transmit a corresponding data signal, and the data signal includes a plurality of data voltages corresponding to the corresponding ones of the plurality of sub-pixels.

The plurality of sub-pixels include a first sub-pixel and a second sub-pixel connected to a same one or different ones of the plurality of data lines. A plurality of data voltages corresponding to a same data signal or different data signals include a first polarity target data voltage corresponding to the first sub-pixel and a second polarity target data voltage corresponding to the second sub-pixel corresponding to a target gray scale, or a same data signal includes a first polarity target data voltage and a second polarity target data voltage corresponding to a same one of the plurality of sub-pixels at different times corresponding to a target gray scale.

The first polarity target data voltage is greater than a reference data voltage. The second polarity target data voltage is less than the reference data voltage. An absolute value of a difference between the first polarity target data voltage and the reference data voltage is not equal to an absolute value of a difference between the second polarity target data voltage and the reference data voltage.

The first sub-pixel and the second sub-pixel corresponding to the first polarity target data voltage and the second polarity target data voltage, respectively, or the same one of the plurality of sub-pixels corresponding to the first polarity target data voltage and the second polarity target data voltage, emit light to exhibit a target brightness corresponding to the target gray scale.

In a third aspect, the present disclosure further provides an electronic device including a display panel as described in any one of the above.

### BRIEF DESCRIPTION OF THE DRAWINGS

FIG. 1, FIG. 7, FIG. 9, and FIG. 10 are flowcharts of a driving method of a display panel provided by some embodiments of the present disclosure.

FIGS. 2 to 6 and 8 are waveform diagrams of gate signals and data signals provided by some embodiments of the present disclosure.

FIG. 11 is a schematic diagram of a gamma curve provided by some embodiments of the present disclosure.

FIG. 12 is a schematic top view of a display panel provided by some embodiments of the present disclosure.

FIG. 13 is a schematic diagram of distribution and connection of sub-pixels, gate lines, and data lines provided by some embodiments of the present disclosure.

FIG. 14 is a block diagram of an electronic device provided by some embodiments of the present disclosure.

### DETAILED DESCRIPTION

The technical solutions in the embodiments of the present disclosure will be described clearly and completely hereinafter with reference to the accompanying drawings. Apparently, the described embodiments are only a part of but not all embodiments of the present disclosure. All other embodiments obtained by those skilled in the art based on the embodiments of the present disclosure without creative efforts shall fall within the protection scope of the present disclosure.

In the description of the present disclosure, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In addition, it should be noted that the accompanying drawings only provide structures closely related to the present disclosure, and some details not related to the invention are omitted, so as to simplify the accompanying drawings and make the inventive points clear at a glance, and do not indicate that the actual device is identical to the accompanying drawings, and do not limit the actual device.

The term “embodiment” mentioned in the present disclosure means that specific features, structures, or characteristics described in conjunction with the embodiments may be included in at least one embodiment of the present disclosure. The occurrence of the term at various locations in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

Beneficial effects: The present disclosure provides a display panel and a driving method thereof, and an electronic device. Based on the same target gray scale having different polarities of the first polarity target data voltage (greater than the reference data voltage) and the second polarity target data voltage (less than the reference data voltage), the absolute value of the difference between the first polarity target data voltage and the reference data voltage is provided to be not equal to the absolute value of the difference between the second polarity target data voltage and the reference data voltage. The first polarity target data voltage or the second polarity target data voltage are applied to a same sub-pixel in a time-sharing manner, or the first polarity target data voltage and the second polarity target data voltage are applied to two different sub pixels in a time-sharing manner or in a simultaneous manner, so that while the sub pixels emit light to exhibit a target brightness corresponding to the target gray scale, the distance that the gate pulse moves away from the data pulse corresponding to the next row of sub pixels may be reduced to increase the overlap area between the gate pulse and each corresponding data pulse. The effective charging time of each sub pixel may be increased, and the phenomenon of color cast or low brightness in mixed color images may be improved.

The present disclosure provides a driving method of a display panel including, but not limited to, the following embodiments and combinations of the following embodiments.

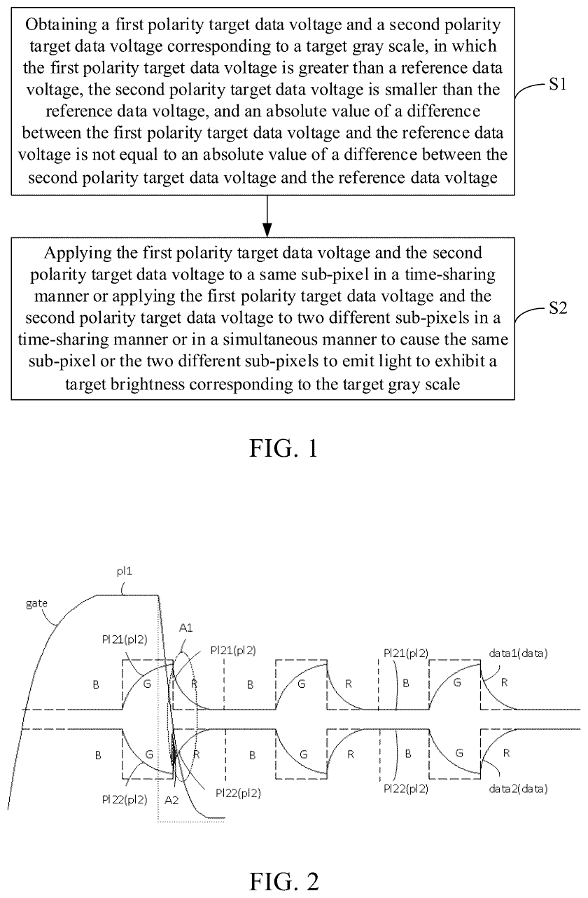

In some embodiments as shown in FIG. 1, the driving method of the display panel may include, but is not limited to, the following steps and a combination of the following steps.

At step S1, a first polarity target data voltage and a second polarity target data voltage corresponding to a target gray scale is obtained. The first polarity target data voltage is greater than a reference data voltage. The second polarity target data voltage is smaller than the reference data voltage. An absolute value of a difference between the first polarity target data voltage and the reference data voltage is not equal to an absolute value of a difference between the second polarity target data voltage and the reference data voltage.

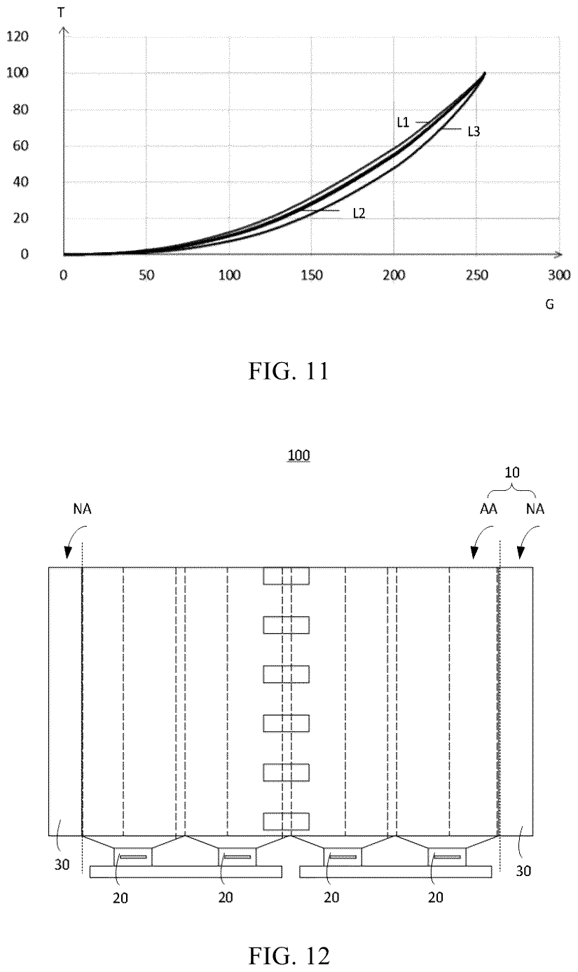

Each sub-pixel in each display panel may have a corresponding gamma curve, and of course, all sub-pixels may also correspond to a same gamma curve. Each sub-pixel may have a corresponding gray scale table, and the gray scale table may include a plurality of gray scale values and corresponding data voltages. Specifically, as shown in FIG. 11, the abscissa of the gamma curve may represent a plurality of gray scale values G acting on the corresponding sub-pixels, and the ordinate of the gamma curve may represent a brightness value T exhibited by the sub-pixel emitting light under the action of a voltage value corresponding to the gray scale values. It may be considered that the relationship between the brightness value T and the gray scale value G in different gamma curves (e.g., L1, L2, and L3, is different). However, it may be considered that each gamma curve conforms to the formula T=(G/Gmax)\hat{ }gamma. The gamma parameters of different curves are different, and Gmax is the maximum value of the plurality of gray scale values G. In particular, when the relationship between the brightness value and the gray scale value is provided based on human visual system, the corresponding gamma curve is a standard gamma curve (such as L2, and the corresponding gamma parameter thereof may be equal to 2.2). That is, it may be considered that in the standard gamma curve L2, the brightness value T and the change thereof coincide with a brightness value and a change thereof that the corresponding grayscale value G should have as perceived by the human eye. Therefore, the first polarity target data voltage and the second polarity target data voltage corresponding to the target gray scale in the embodiments may be understood as data voltages corresponding to the target gray scale values in the above-described gray scale table.

Further, the display panel may have a polarity inversion function, such as frame inversion or column inversion, that is, the polarity of data voltages applied to a plurality of sub-pixels in two adjacent frames may be reversed, or the polarity of data voltages applied to two adjacent columns of sub-pixels may be reversed. Therefore, in the embodiments, the polarities of the first polarity target data voltage and the second polarity target data voltage corresponding to the target gray scale may be reversed compared with the reference data voltage. The absolute values of the differences between the two and the reference data voltage may be approximately equal (The term “approximately equal” is due to the statement in step S1 that “an absolute value of a difference between the first polarity target data voltage and the reference data voltage is not equal to an absolute value of a difference between the second polarity target data voltage and the reference data voltage”, but it may still be considered that the difference between the two absolute values is small). Taking the display panel as a liquid crystal display panel as an example in the embodiments, it may be considered that when the first polarity target data voltage and the second polarity target data voltage are applied to the sub-pixels respectively, the liquid crystal may be deflected in two opposite directions by almost the same angle to transmit a similar amount of light, thus exhibiting approximate brightness. The brightness may be called the brightness value corresponding to the target gray scale value in the gamma curve.

Specifically, for the liquid crystal display panel, the reference data voltage may be understood as a voltage applied to a common electrode. Whether a pixel electrode is applied with the first polarity target data voltage or the second polarity target data voltage, the difference is mainly that the deflection directions of the liquid crystal molecules are opposite, However, the absolute values of the angles between the deflection directions and the vertical direction may be regarded as “almost the same” as described above, so that the brightness of the light emitted by the sub-pixels is “approximate”. For the self-luminous display panel, the reference data voltage may be understood as a data voltage corresponding to the gray scale value of 0. If the operating polarities of pixel driving circuits corresponding to the first polarity target data voltage and the second polarity target data voltage are also provided to be reversed (that is, the polarities of the data voltages required for light emission of the sub-pixels are different), the data voltages acting on the two sub-pixels are the first polarity target data voltage and the second polarity target data voltage, respectively. It may also be considered that the brightness of the light emitted by the two sub-pixels is “approximate”, and the corresponding two gray scale values may be considered equal.

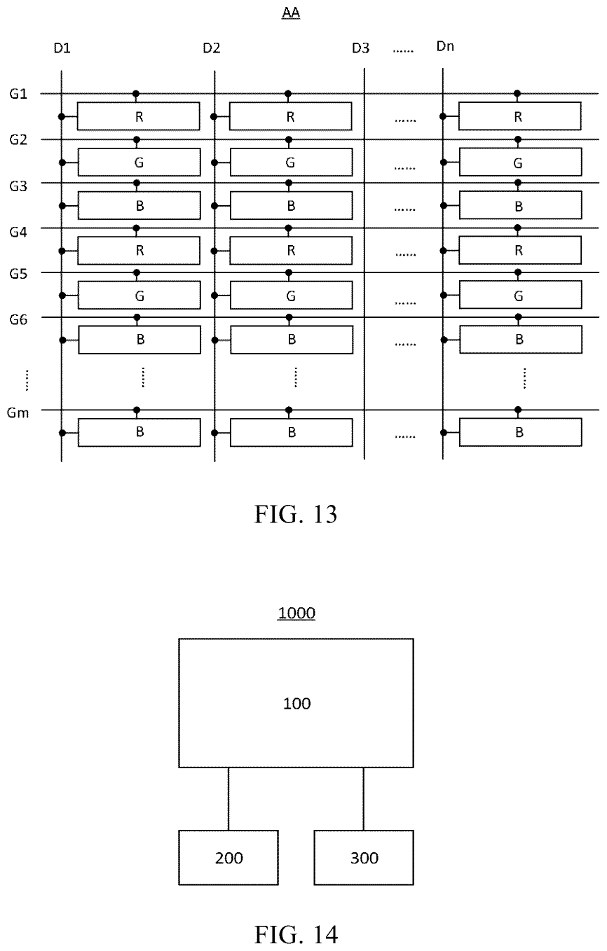

For convenience of description in the present disclosure, as shown in FIGS. 12 and 13, the display panel 100 may include a panel main body 10, a plurality of source driver chips 20 electrically connected to the panel main body 10. The panel main body may be provided with a plurality of sub-pixels located in a display region AA, a plurality of gate lines, a plurality of data lines, and a gate driver circuit 30 located in a non-display region NA. The plurality of sub-pixels may include three sub-pixels R, G, and B having different colors. The plurality of gate lines may include m gate lines G1, G2, G3 to Gm, where m is a positive integer and an integer multiple of 3. The plurality of data lines may include n data lines D1, D2, D3 to Dn, where n is a positive integer. The embodiments are described by an example in which the plurality of sub-pixels (including R, G, and B) are arranged in an array, sub-pixels (including R, G, and B) located in a same column are connected to a same data line (one of D1, D2, D3 to Dn) to be applied with a same data signal, and sub-pixels (including R, G, and B) located in a same row are connected to a same gate line (one of G1, G2, G3 to Gm) to be applied with the same gate signal, but the sub-pixel arrangement is not limited thereto.

Each gate line (one of G1, G2, G3 to Gm) may be electrically connected to a corresponding gate driving unit in the gate driving circuit 30 to receive a gate signal generated therefrom. Each gate signal includes corresponding gate pulses (The peak value of the voltage value corresponding to the gate pulse may be referred to as a “gate voltage”). A plurality of gate pulses corresponding to a plurality of gate signals are sequentially arranged on the time axis to control a plurality of rows of sub-pixels (including a plurality of rows R, G and B) to be turned on sequentially. Each source driver chip 20 may be electrically connected to a plurality of data lines D1, D2, D3 to Dn so that each data line (each of D1, D2, D3 to Dn) may receive a corresponding data signal. Each data signal includes a plurality of data pulses (The peak value of the voltage value corresponding to the data pulse may be referred to as a “data voltage”) corresponding to a plurality of sub-pixels (including R, G, B). The arrangement order of the plurality of data pulses on the time axis is the same as the arrangement order of the plurality of gate pulses corresponding to the corresponding plurality of sub-pixels (including R, G, B), so as to load the corresponding data pulses onto the corresponding sub-pixels (R, G, B) when the corresponding sub-pixels (R, G, B) is turned on.

It should be noted that as shown in FIG. 2, the data signals (data) includes a first polarity data signal (data1) and a second polarity data signal (data2). The absolute value of the voltage value of the first polarity data signal (data1) is greater than or equal to the reference data voltage. The absolute value of voltage value of the second polarity data signal (data2) is equal to or less than the reference data voltage. The first polarity data signal (data 1) includes a plurality of first polarity data pulses p21. The second polarity data signal (data 2) includes a plurality of second polarity data pulses pl22. The peak value of the voltage value of the first polarity data pulse pl21 is defined as a first polarity data voltage. The peak value of the voltage value of the second polarity data pulse pl2 is defined as a second polarity data voltage. Due to the attenuation problem when the gate signal (gate) and the data signals (data) are applied to the current row of sub-pixels (e.g., the green sub-pixels G), the trailing of the corresponding gate pulse pl1 at the end time will intersect with the data pulse pl2 corresponding to the next-row of sub-pixels (e.g., the red sub-pixels R), and the current row of sub-pixels may be mischarged. The mischarging risk region A1 may be understood as a region where the data pulse pl2 corresponding to the next row of sub-pixels (e.g., the red sub-pixels R) is close to the data pulse pl2 corresponding to the next row of sub-pixels (e.g., the green sub-pixels G). The actual mischarging region A2 may be understood as a region where the gate pulse pl1 corresponding to the current row of sub-pixels (e.g., the green sub-pixels G) overlaps with the data pulse pl2 corresponding to the next row of sub-pixels (e.g., the red sub-pixels R).

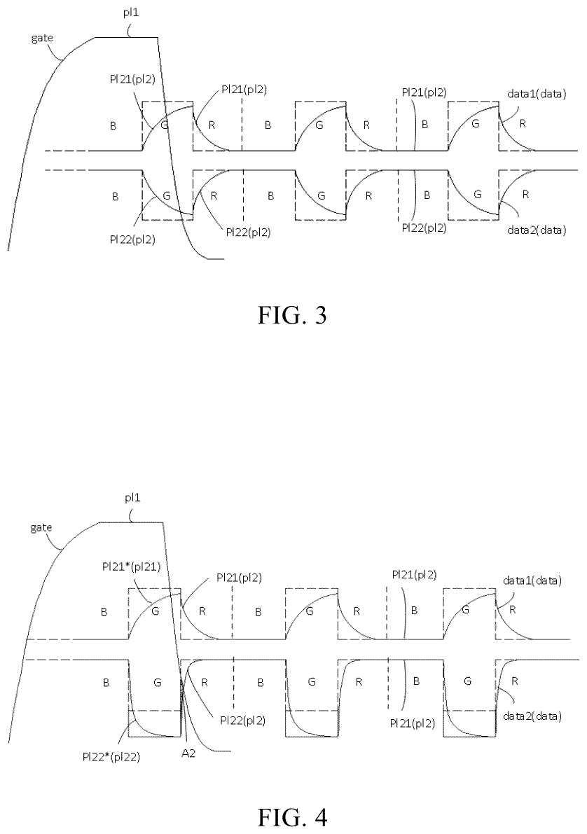

Therefore, as shown in FIG. 3 compared with FIG. 2, the gate pulse pl1 corresponding to the current row of sub-pixels (e.g., the green sub-pixels G) may move in a direction away from the corresponding data pulse pl2 to reduce the above-described mischarging risk, but the area of the overlapping region between the two may be smaller, resulting in insufficient optimal charging time for the current row of sub-pixels (e.g., the green sub-pixels G). For convenience of description, the first polarity data pulse pl21 corresponding to the current row of sub-pixels is defined as the first polarity target data pulse pl21* (The peak value of the voltage value corresponding to the first polarity target data pulse pl21* is the first polarity target data voltage described above) or the second polarity target data pulse pl22* (The peak value of the voltage value corresponding to the second polarity target data pulse pl22* is the second polarity target data voltage described above).

The degree of difference between the first polarity target data voltage and the corresponding gate voltage, is different from the degree of difference between the second polarity target data voltage and the corresponding gate voltage (for example, the difference between the second polarity target data voltage and the corresponding gate voltage is larger). The influence of the trailing of the gate pulse pl1 on one of the data pulses pl2 (e.g., the second polarity target data pulse pl22*) is more severe. Therefore, the distance of the corresponding gate pulse pl1 is provided on the basis that there is no overlapping region between the current gate pulse pl1 and the data pulse pl2 (i.e. the next second polarity data pulse pl22) corresponding to the next row of sub-pixels (e.g., the red sub-pixel R) having a greater influence.

At step S2, the first polarity target data voltage and the second polarity target data voltage are applied to the same sub-pixel in a time-sharing manner, or the first polarity target data voltage and the second polarity target data voltage are applied to two different sub-pixels in a time-sharing manner or in a simultaneous manner, so that the sub-pixels emit light to exhibit a target brightness corresponding to the target gray scale.

The term “target brightness” in step S2 may be understood as a brightness value corresponding to the target gray scale in the gamma curve. Specifically, in the embodiments, the difference between the first polarity target data voltage and the reference voltage and the difference between the second polarity target data voltage corresponding to the same target gray scale obtained in step S1 and the reference voltage are differently provided. The same sub-pixel is applied with the first polarity target data voltage and the second polarity target data voltage in the time-sharing manner, or the two different sub-pixels (of the same color) are applied with the first polarity target data voltage and the second polarity target data voltage to emit with a target brightness. The first polarity target data voltage or the second polarity target data voltage may be defined by the target brightness.

Specifically, as shown in FIG. 4, in the embodiments, the difference between the first polarity target data voltage corresponding to the current row of sub-pixels (e.g., the green sub-pixels G) and the target data voltage is different form the difference between the second polarity target data voltage and the reference data voltage, so, the differences between the two and the corresponding gate voltage are also different (taking the first polarity target data voltage being closer to the gate voltage as an example). The absolute value of the difference between the first polarity target data voltage and the reference data voltage is provided to be not equal to the absolute value of the difference between the second polarity target data voltage and the reference data voltage (that is, the difference between the second polarity target data voltage and the reference data voltage is larger), that is, the amplitude of the first polarity target data voltage or the second polarity target data voltage compared with the reference data voltage is larger (that is, the amplitude of the second polarity target data voltage is larger), so that the speed of rising or falling when the first polarity target data voltage is jumped to the next first polarity data voltage is improved. The jump of the second polarity target data voltage is understood in the same way.

It can be understood that, as shown in FIG. 4, based on the embodiments, when a data signal jumps from a first polarity target data voltage (or a second polarity target data voltage) corresponding to the current row of sub-pixels (e.g., the green sub-pixels G) to a first polarity target data voltage (or a second polarity data voltage) corresponding to the next row of sub-pixels (e.g., red sub-pixels R), the speed of rising or falling when the first polarity target data voltage jumps to the next first polarity data voltage (e.g., the speed of rising or falling when the second polarity target data pulse pl22* corresponding to the green sub-pixel G jumps to the second polarity data pulse pl22 corresponding to the red sub-pixel R) is improved. Compared with FIG. 2, in the embodiments (referring to but not limited to FIG. 4), on the premise that the gate pulse pl1 may be avoided to move in a direction (referring to but not limited to FIG. 3) away from the corresponding data pulse pl2 (e.g., the next second polarity data pulse pl22), the area of the overlapping region (i.e., the actual mischarging region A2) between the gate pulse pl1 and the data pulse (i.e., the second polarity data pulse pl22) of the first polarity data voltage corresponding to the next row of sub-pixels (i.e., the red sub-pixels R) may be smaller. After replacing the first polarity target data voltage with the second polarity target data voltage in this paragraph, it should be understood in the same way.

In another way, it may also be considered that based on the actual mischarge regions A2 of the same area, in the embodiments, since the speed of rising or falling when the first polarity target data voltage jumps to the next first polarity data voltage is improved, it is more conducive to forming the actual mischarge region A2 with the smaller area, so that the distance that the gate pulse pl1 moves away from the data pulse pl2 corresponding to the next row of sub pixels may be reduced to increase the overlap area between the gate pulse pl1 and each corresponding data pulse pl2. The effective charging time of each sub pixel may be increased, and the phenomenon of color cast or low brightness in mixed color images may be improved. After replacing the first polarity target data voltage with the second polarity target data voltage in this paragraph, it should be understood in the same way.

Of course, as shown in FIG. 6, based on FIG. 4, the gate pulse pl1 may further move in the direction away from the data pulse of second polarity data voltage corresponding to the next row of sub-pixels (i.g., the red sub-pixels R), so that there is no overlapping region between the two, that is, there is no actual mischarging region A2, and the mischarging risk may be further reduced.

It should be noted that the term “target brightness” in the embodiments may refer to a brightness range. It can be considered that the brightness presented by the two sub-pixels or the same sub-pixel applied with the first polarity target data voltage and the second polarity target data voltage belongs to the target brightness. The difference between the two brightness is considered to be hardly recognizable by human eyes. The effective charging time of the sub-pixels may be more sufficient to improve the phenomenon of color cast or low brightness in mixed color images

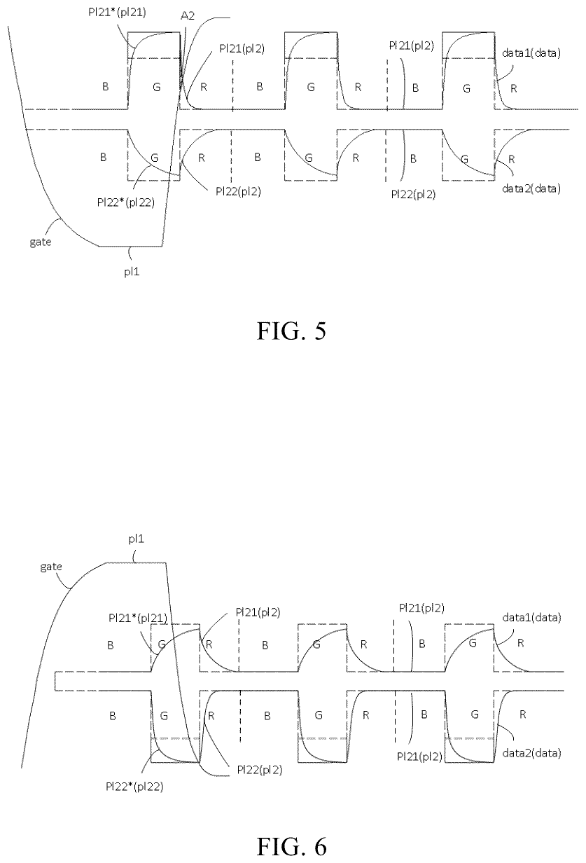

In some embodiments, the step S2 may include, but is not limited to, the following steps: a gate voltage is applied to the sub-pixels to turn on the sub-pixels, the first polarity target data voltage and the second polarity target data voltage are applied to the same sub-pixel in the time-sharing manner, or the first polarity target data voltage and the second polarity target data voltage are applied to the two different sub-pixels in the time-sharing manner or in the simultaneous manner. As shown in FIG. 4, the gate voltage (being a peak value of a corresponding voltage value of the gate pulse pl1) is greater than the first polarity target data voltage (acting on the sub-pixels (e.g., the green sub-pixels G) emitting light and being greater than the peak value of the voltage value of the reference data voltage) and the second polarity target data voltage (acting on the sub-pixel (e.g., the green sub-pixel G) emitting light and being less than a voltage value of the reference data voltage). The absolute value of the difference between the first polarity target data voltage and the reference data voltage is less than the absolute value of the difference between the second polarity target data voltage and the reference data voltage. Alternatively, as shown in FIG. 5, the gate voltage is smaller than the first polarity target data voltage and the second polarity target data voltage. The absolute value of the difference between the first polarity target data voltage and the reference data voltage is larger than the absolute value of the difference between the second polarity target data voltage and the reference data voltage.

It can be understood that, as shown in FIG. 4, the polarity of the gate voltage and the polarity of the first polarity target data voltage are the same. It can be considered that the mischarging risk caused by the trailing of the gate pulse pl1 corresponding to the next second polarity data pulse pl22 is large, so the absolute value of the difference between the second polarity target data voltage and the reference data voltage may be provided to be larger in the embodiments, so that the jump (rising) speed of the data signal from the second polarity target data voltage corresponding to the current row of sub-pixels (e.g., the green sub-pixels G) to the second polarity data voltage corresponding to the next row sub-pixels (i.e., the red pixels R) is sped up. The distance that the gate pulse pl1 moves away from the data pulse pl2 corresponding to the next row of sub pixels (e.g., the red sub-pixels R) may be reduced to increase the effective charging time of the sub pixels, and to improve the phenomenon of color cast or low brightness in mixed color images.

Similarly, as shown in FIG. 5, the polarity of the gate voltage and the polarity of the second polarity target data voltage are the same. It can be considered that the mischarging risk caused by the trailing of the gate pulse pl1 corresponding to the next first polarity data pulse pl21 is large, so the absolute value of the difference between the first polarity target data voltage and the reference data voltage may be provided to be larger in the embodiments, so that the jump (rising) speed of the data signal from the second polarity target data voltage corresponding to the current row of sub-pixels (e.g., the green sub-pixels G) to the second polarity data voltage corresponding to the next row sub-pixels (i.e., the red pixels R) is sped up. The distance that the gate pulse pl1 moves away from the data pulse pl2 corresponding to the next row of sub pixels (e.g., the red sub-pixels R) may be reduced to increase the effective charging time of the sub pixels, and to improve the phenomenon of color cast or low brightness in mixed color images.

In some embodiments, as shown in FIGS. 4 and 5, a charging speed or a discharging speed at which the first polarity target data voltage is converted into the reference data voltage is not equal to a charging speed or a discharging speed at which the second polarity target data voltage is converted into the reference data voltage. The difference between the charging speed and the discharging speed in the embodiments may be understood not to be caused by the degrees of the differences between the first polarity target data voltage and the second polarity target data voltage and the reference data voltage, and may be understood to be caused by differentiating a power control (PWRC) of the first data signal (data1) including the first polarity target data voltage and a PWRC of the second data signal (data2) including the second polarity target data voltage in the source driver chip. For example, the PWRC of the two may be 100% and 120%, respectively. The charge and discharge speeds of the first data signal (data 1) and the second data signal (data 2) may be provided differently by turning on a charge time detection (CTD) function of one of the two. It can be considered that the larger the PWRC is, the faster the charge and discharge speed is, and the faster the charge and discharge speed is when the CTD is turned on than when the CTD is not turned on.

For convenience of description, in FIGS. 4 and 5, taking the first polarity data voltage or the second polarity data voltage corresponding to the blue sub-pixel B and the red sub-pixel R belonging to the reference data voltage as an example for description, that is, the jump from the first polarity target data voltage to the first polarity data voltage may be equivalent to the jump from the first polarity target data voltage to the reference data voltage. The jump from the first polarity data voltage to the first polarity target data voltage may be equivalent to the jump from the reference data voltage to the first polarity target data voltage. The jump from the second polarity target data voltage to the data voltage of the second polarity may be understood in the same way.

Specifically, as shown in FIG. 4, when the mischarging risk caused by the trailing of the gate pulse pl1 corresponding to the second polarity data pulse pl22 is large, the speed of charging or discharging at which the second polarity target data voltage corresponding to the second polarity target data pulse pl22* is converted into the reference data voltage may be faster by, but not limited to the above two ways. The speed of conversion from the second polarity target data voltage to the reference data voltage in the second data signal (data2) may be further improved. As shown in FIG. 5, when the mischarging risk caused by the tailing of the gate pulse pl1 corresponding to the first polarity data pulse pl22 is large, the speed of charging or discharging at which the first polarity target data voltage corresponding to the first polarity target data pulse pl21* is converted into the reference data voltage may be faster by, but not limited to the above two ways. The speed of conversion from the first polarity target data voltage to the reference data voltage corresponding to the second data signal data 2 may be further improved.

Further, in order to further increase the speed of conversion from the first polarity target data voltage or the second polarity target data voltage to the reference data voltage, the charge and discharge speed of conversion from the reference voltage to the first polarity target data voltage or the second polarity target data voltage may be provided differently. Specific ways may also include, but are not limited to, differentiated settings of the PWRC and the CTD described above.

In the embodiments, as shown in FIG. 7, the display panel includes a plurality of the sub-pixels, and the plurality of the sub-pixels include a first sub-pixel and a second sub-pixel. The step S1 (taking the target gray scale corresponding to the first polarity target data voltage as an example) may include, but is not limited to, the following steps.

At step S11, a first sub-polarity target data voltage corresponding to the first sub-pixel and a second sub-polarity target data voltage corresponding to the second sub-pixel in the first polarity target data voltage are obtained. A turned-on time of the first sub-pixel is different from a turned-on time of the second sub-pixel. The first sub-polarity data voltage is not equal to the second sub-polarity data voltage.

It should be noted that the gate signal (gate) and the data signal (data) generated by the driver chip are generally transmitted from one side to the opposite side of the display panel, resulting in different degrees of attenuation of the gate voltage and the data voltage applied to the sub-pixels located at different positions compared with the voltage generated by the source of the driver chip. Due to differences in attenuation degree of the same voltage value on the sub-pixels at different positions, the brightness of the light limited by the sub-pixels at different positions is different even if they correspond to the same gray scale.

The first sub-pixel and the second sub-pixel having different turned-on times in step S11 may be understood as

the two sub-pixels receiving corresponding data voltages at different times. That is, if no intervention is performed, the attenuation degree of the same data voltage corresponding to the same gray scale is different on both the first sub-pixel and the second sub-pixel.

Based on step S11, the step S2 may include, but is not limited to, the following steps.

At step S21, the first sub-polarity target data voltage is applied to the first sub-pixel and the second sub-polarity target data voltage is applied to the second sub-pixel to cause the first sub-pixel and the second sub-pixel to emit light to exhibit the target brightness.

It can be understood that in step S11 in the embodiments, two data voltages (for example, both are first polarity target data voltages for positive polarity data voltages) corresponding to the same gray scale (i.e., target gray scale) of the first sub-pixel and the second sub-pixel at different positions are differentiated to be the first sub-polarity target data voltages and the second sub-polarity target data voltages of different voltage values, respectively, so as to make up for the difference in brightness corresponding to the same gray scale due to the different degree of signal attenuation.

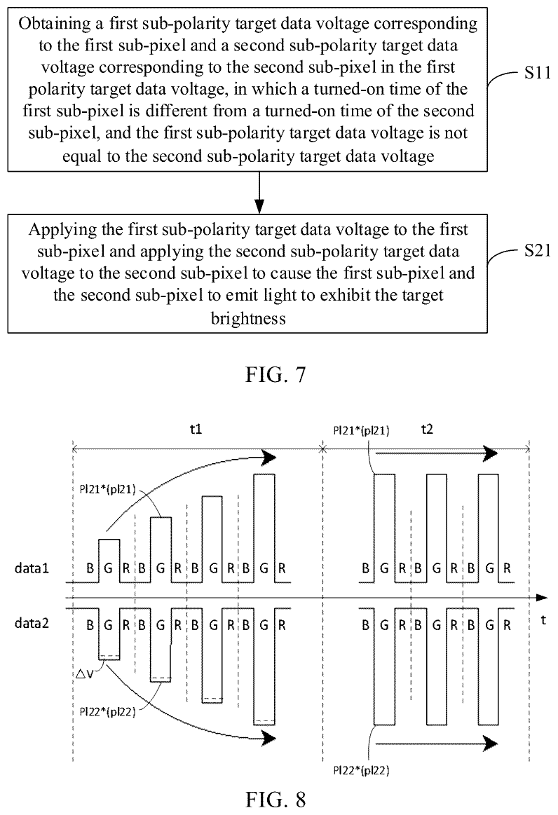

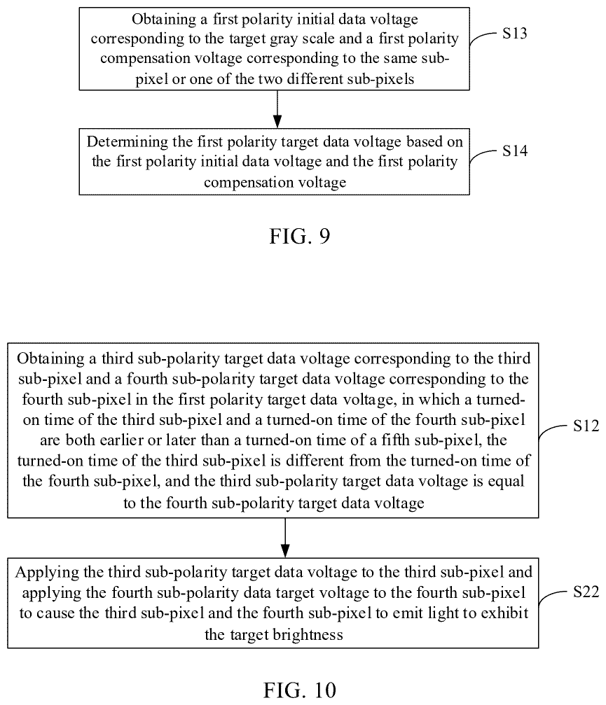

Specifically, as shown in FIG. 8, regardless of the first data signal (data1) or the second data signal (data2), it may be considered that along the positive direction of the time axis t, as analyzed above, any data signal will experience an increasing degree of attenuation. The sub-pixels acted by a plurality of data voltages in the first stage t1 in the first data signal (data1) or the second data signal (data2) may be defined as one of the first sub-pixel and the second sub-pixel. The sub-pixels acted by a plurality of data voltages in the second stage t2 in the first data signal (data)1 or the second data signal (data2) may be defined as another one of the first sub-pixel and the second sub-pixel.

For convenience of description, the sub-pixels acted by a plurality of data voltages in the first stage t1 and the second stage t2 in the first data signal (data1) are defined as the first sub-pixels and the second sub-pixels, respectively. Since the data line first transmits the first sub-polarity target data voltage acting on the first sub-pixel and then transmits the second sub-polarity target data voltage acting on the second sub-pixel, it may be considered that the distance between the first sub-pixel and the driver chip is smaller than the distance between the second sub-pixel and the driver chip, that is, the second sub-polarity target data voltage is more severely attenuated than the first sub-polarity target data voltage. Therefore, as shown in FIG. 8, in the embodiments, the second sub-polarity target data voltage (belonging to the first polarity target data voltage) in the second stage t2 in the first data signal (data1) is provided to be larger than the first sub-polarity target data voltage (also belonging to the first polarity target data voltage) in the first stage t1 to compensate for the brightness difference due to the attenuation difference.

Similarly, the second polarity target data voltage in the second stage t2 in the second data signal (data2) may be provided to be greater than the second polarity target data voltage in the first stage t1 to compensate for the brightness difference due to the attenuation difference.

In some embodiments, as shown in FIG. 9, the step S1 (taking the target gray scale corresponding to the first polarity target data voltage as an example) may include, but is not limited to, the following steps.

At step S13, a first polarity initial data voltage corresponding to the target gray scale and a first polarity compensation voltage corresponding to the sub-pixel are obtained.

Since the data voltage is generated by the source driving chip, and a distance from the source driving chip to a row of green sub-pixels G closest to the source driving chip also leads to certain attenuation of the data voltage, the attenuation value (i.e., the first polarity compensation voltage) of the first polarity data voltage resulting from the distance and the corresponding voltage value (i.e., the first polarity initial data voltage) of the target gray scale without considering the above attenuation of the first polarity data voltage may be measured experimentally.

At step S14, the first polarity target data voltage is determined based on the first polarity initial data voltage and the first polarity compensation voltage.

As shown in FIG. 8, it can be understood that since a first polarity target data pulse pl21* or a first second polarity target data pulse pl22* on the time axis t corresponds to a row of green sub-pixels G closest to the driving chip, it may be considered that the setting of the first polarity target data pulse pl21* and the first second polarity target data pulse pl22* has taken into account the attenuation (i.e., the first polarity compensation voltage) of the data signal from the source driver chip to the “a row of green sub-pixels G closest to the driving chip”. The corresponding first polarity compensation voltage may be superimposed on the basis of the first polarity initial data voltage corresponding to the target gray scale to obtain the corresponding first polarity target data voltage. Therefore, it may be considered that the brightness of the light emitted by “a row of green sub-pixels G closest to the driving chip” by the action of the first polarity target data pulse pl21* or the first second polarity target data pulse pl22* may be equal to the target brightness.

Further, as shown in FIG. 8, as described above with respect to FIG. 4, taking the mischarging risk caused by the trailing of the gate pulse pl1 corresponding to the second polarity data pulse pl22 as an example, there is a second polarity target data voltage of the corresponding second polarity target data pulse pl22* corresponding to at least one row of green sub-pixels G may be larger than a first polarity target data voltage of the corresponding first polarity target data pulse pl21*. For example, the absolute value of the difference between the two is ΔV, and ΔV may be equal to 0.2 V.

In some embodiments, as shown in FIG. 10, the display panel includes a plurality of the sub-pixels, and the plurality of the sub-pixels include a third sub-pixel and a fourth sub-pixel. The step S1 (taking the target gray scale corresponding to the first polarity target data voltage as an example) may include, but is not limited to, the following steps.

At step S12, a third sub-polarity target data voltage corresponding to the third sub-pixel and a fourth sub-polarity target data voltage corresponding to the fourth sub-pixel in the first polarity target data voltage are obtained. A turned-on time of the third sub-pixel and a turned-on time of the fourth sub-pixel are both earlier or later than a turned-on time of a fifth sub-pixel. The turned-on time of the third sub-pixel is different from the turned-on time of the fourth sub-pixel. The third sub-polarity data voltage is equal to the fourth sub-polarity data voltage.

Similarly, the third sub-pixel, the fourth sub-pixel, and the fifth sub-pixel having different turned-on times in step S12 may also be understood the three sub-pixels receiving corresponding data voltages at different times. That is, if no intervention is performed, the attenuation degree of the same data voltage corresponding to the same gray scale is different in the three sub-pixels.

Further, for convenience of description, a region closer to the driver chip and a region farther away from the driver chip are referred to as a proximal region and a distal region, respectively. Since the data signal is transmitted to the proximal region first, the attenuation speed of the gate voltage and the data voltage in the proximal region may be much greater than the attenuation degree of the gate voltage and the data voltage in the distal region, resulting in a smaller amplitude of the signal transmitted to the distal region, but the attenuation degree is equivalent.

Based on step S12, the step S2 may include, but is not limited to, the following steps.

At step S22, the third sub-polarity target data voltage is applied to the third sub-pixel and the fourth sub-polarity data target voltage is applied to the fourth sub-pixel to cause the third sub-pixel and the fourth sub-pixel to emit light to exhibit the target brightness.

Specifically, as shown in FIG. 8, the fifth sub-pixel in step S12 in the embodiments may be understood to be located in the proximal region, that is, the corresponding first polarity target data voltage is in the first stage t1. The third sub-pixel and the fourth sub-pixel are both located in the distal region, that is, the corresponding two first polarity target data voltages are in the second stage t2. As described above, due to the small attenuation difference between the third sub polarity target data voltage and the fourth sub polarity target data voltage transmitted to the third and fourth sub pixels respectively in the second stage t2, the third sub polarity target data voltage and the fourth sub polarity target data voltage may be provided to be equal to save the calculation and storage capacity for the data voltages.

Of course, for two sub-pixels that are closer to each other (the phase difference between the two corresponding data voltages is small, or the distance between the two corresponding data lines is small), the two data voltages corresponding to the two sub-pixels may be provided to be the same, so as to save the calculation and storage capacity of the data voltages.

Further, for two sub-pixels that are far apart (the phase difference between the two corresponding data voltages is large, or the distance between the two corresponding data lines is large), the two data voltages corresponding to the two sub-pixels may be provided to be different. The data voltages corresponding to the two sub-pixels may be further obtained by linear interpolation, so as to save the calculation and storage capacity of the data voltages.

It should be noted that the gate driving unit, the source driving chip, and the like mentioned in the present disclosure may be substantially composed of at least one component, and may include, for example, at least one of a transistor, a capacitor, a resistor, or a wire electrically connected between different components, and the specific configuration may refer to the described above.

The present disclosure also provides a display panel. The display panel includes a plurality of the sub-pixels and a plurality of the data lines. Each of the data lines is connected to corresponding ones of the sub-pixels to transmit a corresponding data signal. The data signal includes a plurality of data voltages corresponding to the ones of the sub-pixels. The plurality of sub-pixels include a first sub-pixel and a second sub-pixel connected to a same or different data lines. The corresponding data voltages in a same or different data signals include a first polarity target data voltage corresponding to the first sub-pixel and a second polarity target data voltage corresponding to the second sub-pixel corresponding to a target gray scale, or a same data signal includes a first polarity target data voltage and a second polarity target data voltage corresponding to a same one of the plurality of sub-pixels at different times corresponding to the target gray scale.

The first polarity target data voltage is greater than a reference data voltage. The second polarity target data voltage is less than the reference data voltage. An absolute value of a difference between the first polarity target data voltage and the reference data voltage is not equal to an absolute value of a difference between the second polarity target data voltage and the reference data voltage.

The first sub-pixel and the second sub-pixel corresponding to the first polarity target data voltage and the second polarity target data voltage, respectively, or the same one of the plurality of sub-pixels corresponding to the first polarity target data voltage and the second polarity target data voltage, emit light to exhibit a target brightness corresponding to the target gray scale.

As discussed above, in the embodiments, there is no limitation on whether the first sub-pixel and the second sub-pixel are connected to the same data line. There is no limitation on whether the first polarity target data voltage and the second polarity target data voltage having different polarities corresponding to the same target gray scale are applied to the same sub-pixel or applied to the first sub-pixels and the second sub-pixels.

It can be understood that in the embodiments, the situation of the sub-pixels specifically acting on the first polarity target data voltage and the second polarity target data voltage is not limited. By differentiating the difference between the two and the reference data voltage, and in combination with the above discussion, it can be seen that for the display panel, it is more conducive to forming the actual mischarging region A2 with a smaller area, so that the distance that the gate pulse pl1 moves away from the data pulse pl2 corresponding to the next row of sub pixels (i.g., the red sub-pixels) may be reduced to increase the overlap area between the gate pulse pl1 and each corresponding data pulse pl2. The effective charging time of each sub pixel may be increased, and the phenomenon of color cast or low brightness in mixed color images may be improved.

In some embodiments, the display panel further includes a plurality of the gate lines. Each of the gate lines is electrically connected to corresponding ones of the sub-pixels to transmit a corresponding gate signal. The gate signal includes gate voltages for turning on the corresponding ones of the sub-pixels. The gate voltages are greater than the first polarity target data voltage and the second polarity target data voltage. An absolute value of a difference between the first polarity target data voltage and the reference data voltage is less than an absolute value of a difference between the first polarity target data voltage and the reference data voltage. Alternatively, the gate voltages are less than the first polarity target data voltage and the second polarity target data voltage. The absolute value of the difference between the first polarity target data voltage and the reference data voltage is greater than the absolute value of the difference between the first polarity target data voltage and the reference data voltage.

In particular, it can be understood in combination with the above discussion with respect to FIGS. 4 and 5.

In some embodiments, the plurality of sub-pixels include a third sub-pixel and a fourth sub-pixel connected to the same data line or to two different data lines, respectively. The third sub-pixel and the fourth sub-pixel are connected to two different gate lines, respectively, so as to have different turned-on times. the plurality of data voltages corresponding to a same or different data signals comprise a first sub-polarity target data voltage corresponding to the third sub-pixel and a second sub-polarity target data voltage corresponding to the fourth sub-pixel corresponding to the target gray scale, and the first sub-polarity target data voltage is not equal to the second sub-polarity target data voltage. The third sub-pixel and the fourth sub-pixel applied with the first sub-polarity target data voltage and the second sub-polarity target data voltage, respectively, emit light to exhibit the target brightness.

Specifically, referring to the above discussion with respect to FIG. 8, the sub-pixels acted by a plurality of data voltages in the first stage t1 in the first data signal (data1) or the second data signal (data2) may be defined as one of the third sub-pixel and the fourth sub-pixel. The sub-pixels acted by a plurality of data voltages in the second stage t2 in the first data signal (data)1 or the second data signal (data2) may be defined as another one of the third sub-pixel and the fourth sub-pixel.

For convenience of description, the sub-pixels acted by the plurality of data voltages in the first stage t1 and the second stage t2 in the first data signal (data1) are defined as a third sub-pixel and a fourth sub-pixel, respectively. Since the data line first transmits the first sub-polarity target data voltage acting on the third sub-pixel and then transmits the second sub-polarity target data voltage acting on the fourth sub-pixel, it may be considered that the distance between the third sub-pixel and the driver chip is smaller than the distance between the fourth sub-pixel and the driver chip, that is, the second sub-polarity target data voltage is more severely attenuated than the first sub-polarity target data voltage. Therefore, as shown in FIG. 8, in the embodiments, the second sub-polarity target data voltage (belonging to the first polarity target data voltage) in the second stage t2 in the first data signal (data1) is provided to be larger than the first sub-polarity target data voltage (also belonging to the first polarity target data voltage) in the first stage t1 to compensate for the brightness difference due to the attenuation difference, so as to realize that the third sub-pixel and the fourth sub-pixel all emit light to exhibit almost the same target brightness.

Similarly, as shown in FIG. 8, the second polarity target data voltage in the second stage t2 in the second data signal (data2) may be provided to be greater than the second polarity target data voltage in the first stage t1 to compensate for the brightness difference due to the attenuation difference.

The present disclosure also provides an electronic device. As shown in FIG. 14, the electronic device 1000 includes the display panel 100 as described above, and an input device 200 and an output device 300 electrically connected to the display panel 100. The input device 200 is configured to supply power, control data, and display data to the display panel 100. The output device 300 is configured to output information generated by the display panel 100.

The display panel, the driving method thereof, and the electronic device provided by the embodiments of the present disclosure are described in detail above. The principle and implementations of the present disclosure are described in this specification by using specific examples. The description about the foregoing embodiments is merely provided to help understand the method and core ideas of the present disclosure. Those skilled in the art should understand that they may still make modifications to the technical solutions described in the foregoing embodiments or make equivalent replacements to some technical features thereof, without departing from the scope of the technical solutions of the embodiments of the present disclosure.

1. A driving method of a display panel, comprising:
obtaining a first polarity target data voltage and a second polarity target data voltage corresponding to a target gray scale, wherein the first polarity target data voltage is greater than a reference data voltage, the second polarity target data voltage is smaller than the reference data voltage, and an absolute value of a difference between the first polarity target data voltage and the reference data voltage is not equal to an absolute value of a difference between the second polarity target data voltage and the reference data voltage; and
applying the first polarity target data voltage and the second polarity target data voltage to a same sub-pixel in a time-sharing manner or applying the first polarity target data voltage and the second polarity target data voltage to two different sub-pixels in a time-sharing manner or in a simultaneous manner to cause the same sub-pixel or the two different sub-pixels to emit light to exhibit a target brightness corresponding to the target gray scale.

2. The driving method of the display panel of claim 1, wherein a step of applying the first polarity target data voltage and the second polarity target data voltage to the same sub-pixel in the time-sharing manner or applying the first polarity target data voltage and the second polarity target data voltage to the two different sub-pixels in the time-sharing manner or in the simultaneous manner comprises:
applying a gate voltage to the same sub-pixel to turn on the sub-pixel, and applying the first polarity target data voltage and the second polarity target data voltage to the same sub-pixel in the time-sharing manner; or applying a gate voltage to the two different sub-pixels to turn on the two different sub-pixels, and applying the first polarity target data voltage and the second polarity target data voltage to the two different sub-pixels in the time-sharing manner or in the simultaneous manner;
wherein the gate voltage is greater than the first polarity target data voltage and the second polarity target data voltage, and the absolute value of the difference between the first polarity target data voltage and the reference data voltage is less than the absolute value of the difference between the second polarity target data voltage and the reference data voltage; or
the gate voltage is less than the first polarity target data voltage and the second polarity target data voltage, and the absolute value of the difference between the first polarity target data voltage and the reference data voltage is greater than the absolute value of the difference between the second polarity target data voltage and the reference data voltage.

3. The driving method of the display panel of claim 1, wherein a charging speed or a discharging speed at which the first polarity target data voltage is converted into the reference data voltage is not equal to a charging speed or a discharging speed at which the second polarity target data voltage is converted into the reference data voltage.

4. The driving method of the display panel of claim 3, wherein a charging speed or a discharging speed at which the reference voltage is converted into the first polarity target data voltage is not equal to a charging speed or a discharging speed at which the reference voltage is converted into the second polarity target data voltage.

5. The driving method of the display panel of claim 1, wherein the display panel comprises a plurality of sub-pixels, and the plurality of the sub-pixels comprise a first sub-pixel and a second sub-pixel, and a step of obtaining the first polarity target data voltage corresponding to the target gray scale comprises:
obtaining a first sub-polarity target data voltage corresponding to the first sub-pixel and a second sub-polarity target data voltage corresponding to the second sub-pixel in the first polarity target data voltage, wherein a turned-on time of the first sub-pixel is different from a turned-on time of the second sub-pixel, and the first sub-polarity target data voltage is not equal to the second sub-polarity target data voltage;
wherein a step of applying the first polarity target data voltage or the second polarity target data voltage to the same sub-pixel in the time-sharing manner or applying the first polarity target data voltage and the second polarity target data voltage to the two different sub-pixels in the time-sharing manner or in the simultaneous manner comprises:
applying the first sub-polarity target data voltage to the first sub-pixel and applying the second sub-polarity target data voltage to the second sub-pixel to cause the first sub-pixel and the second sub-pixel to emit light to exhibit the target brightness.

6. The driving method of the display panel of claim 5, further comprising:
transmitting the first sub-polarity target data voltage acting on the first sub-pixel first, and then transmitting the second sub-polarity target data voltage acting on the second sub-pixel.

7. The driving method of the display panel of claim 1, wherein the display panel comprises a plurality of sub-pixels, the plurality of sub-pixels comprise a third sub-pixel and a fourth sub-pixel, and a step of obtaining the first polarity target data voltage corresponding to the target gray scale comprises:
obtaining a third sub-polarity target data voltage corresponding to the third sub-pixel and a fourth sub-polarity target data voltage corresponding to the fourth sub-pixel in the first polarity target data voltage, wherein a turned-on time of the third sub-pixel and a turned-on time of the fourth sub-pixel are both earlier or later than a turned-on time of a fifth sub-pixel, the turned-on time of the third sub-pixel is different from the turned-on time of the fourth sub-pixel, and the third sub-polarity target data voltage is equal to the fourth sub-polarity target data voltage;
wherein a step of applying the first polarity target data voltage or the second polarity target data voltage to the same sub-pixel in the time-sharing manner or applying the first polarity target data voltage and the second polarity target data voltage to the two different sub-pixels in the time-sharing manner or in the simultaneous manner comprises:
applying the third sub-polarity target data voltage to the third sub-pixel and applying the fourth sub-polarity data target voltage to the fourth sub-pixel to cause the third sub-pixel and the fourth sub-pixel to emit light to exhibit the target brightness.

8. The driving method of the display panel of claim 1, wherein a step of obtaining the first polarity target data voltage corresponding to the target gray scale comprises:
obtaining a first polarity initial data voltage corresponding to the target gray scale and a first polarity compensation voltage corresponding to the same sub-pixel or one of the two different sub-pixels; and
determining the first polarity target data voltage based on the first polarity initial data voltage and the first polarity compensation voltage.

9. The driving method of the display panel of claim 1, further comprising:
applying the reference data voltage to a common electrode, wherein the same sub-pixel or the two different sub-pixels emit light based on a difference between a corresponding one of the first polarity target data voltage and the second polarity target data voltage and the reference data voltage.

10. A display panel, comprising:
a plurality of sub-pixels; and
a plurality of data lines, wherein each of the data lines is connected to corresponding ones of the plurality of sub-pixels to transmit a corresponding data signal, and the data signal comprises a plurality of data voltages corresponding to the corresponding ones of the plurality of sub-pixels;
wherein the plurality of sub-pixels comprise a first sub-pixel and a second sub-pixel connected to a same one or different ones of the plurality of data lines; and a plurality of data voltages corresponding to a same data signal or different data signals comprise a first polarity target data voltage corresponding to the first sub-pixel and a second polarity target data voltage corresponding to the second sub-pixel corresponding to a target gray scale, or a same data signal comprises a first polarity target data voltage and a second polarity target data voltage corresponding to a same one of the plurality of sub-pixels at different times corresponding to a target gray scale;
wherein the first polarity target data voltage is greater than a reference data voltage, the second polarity target data voltage is less than the reference data voltage, and an absolute value of a difference between the first polarity target data voltage and the reference data voltage is not equal to an absolute value of a difference between the second polarity target data voltage and the reference data voltage; and
wherein the first sub-pixel and the second sub-pixel corresponding to the first polarity target data voltage and the second polarity target data voltage, respectively, or the same one of the plurality of sub-pixels corresponding to the first polarity target data voltage and the second polarity target data voltage, emit light to exhibit a target brightness corresponding to the target gray scale.

11. The display panel of claim 10, wherein the same one or the different ones of the plurality of data lines is configured to first transmit a first sub-polarity target data voltage acting on the first sub-pixel and then transmit a second sub-polarity target data voltage acting on the second sub-pixel.

12. The display panel of claim 10, further comprising:
a plurality of gate lines, wherein each of the gate lines is electrically connected to corresponding ones of the plurality of sub-pixels to transmit a corresponding gate signal, and the gate signal comprises a plurality of gate voltages configured to turn on corresponding ones of the plurality of sub-pixels;
wherein the plurality of gate voltages are greater than the first polarity target data voltage and the second polarity target data voltage, and the absolute value of the difference between the first polarity target data voltage and the reference data voltage is less than the absolute value of the difference between the first polarity target data voltage and the reference data voltage; or
the plurality of gate voltages are less than the first polarity target data voltage and the second polarity target data voltage, and the absolute value of the difference between the first polarity target data voltage and the reference data voltage is greater than the absolute value of the difference between the first polarity target data voltage and the reference data voltage.

13. The display panel of claim 10, wherein a charging speed or a discharging speed at which the first polarity target data voltage is converted into the reference data voltage is not equal to a charging speed or a discharging speed at which the second polarity target data voltage is converted into the reference data voltage.

14. The display panel of claim 13, wherein a charging speed or a discharging speed at which the reference voltage is converted into the first polarity target data voltage is not equal to a charging speed or a discharging speed at which the reference voltage is converted into the second polarity target data voltage.

15. The display panel of claim 10, wherein the plurality of sub-pixels comprise a third sub-pixel and a fourth sub-pixel connected to a same one or different two of the plurality of data lines respectively, and the third sub-pixel and the fourth sub-pixel are connected to different two of the plurality of gate lines, respectively, to have different turned-on times;
wherein the plurality of data voltages corresponding to a same data signal or different data signals comprise a first sub-polarity target data voltage corresponding to the third sub-pixel and a second sub-polarity target data voltage corresponding to the fourth sub-pixel corresponding to the target gray scale, and the first sub-polarity target data voltage is not equal to the second sub-polarity target data voltage; and
wherein the third sub-pixel and the fourth sub-pixel applied with the first sub-polarity target data voltage and the second sub-polarity target data voltage, respectively, emit light to exhibit the target brightness.

16. The display panel of claim 10, further comprising:
a common electrode applied with the reference data voltage, wherein the same one of the plurality of sub-pixels emits light based on a difference between corresponding one of the first polarity target data voltage and the second polarity target data voltage and the reference data voltage.

17. An electronic device comprising a display panel wherein the display panel comprises:
a plurality of sub-pixels; and
a plurality of data lines, wherein each of the data lines is connected to corresponding ones of the plurality of sub-pixels to transmit a corresponding data signal, and the data signal comprises a plurality of data voltages corresponding to the corresponding ones of the plurality of sub-pixels;
wherein the plurality of sub-pixels comprise a first sub-pixel and a second sub-pixel connected to a same one or different ones of the plurality of data lines; and a plurality of data voltages corresponding to a same or different data signals comprise a first polarity target data voltage corresponding to the first sub-pixel and a second polarity target data voltage corresponding to the second sub-pixel corresponding to a target gray scale, or a same data signal comprises a first polarity target data voltage and a second polarity target data voltage corresponding to a same one of the plurality of sub-pixels at different times corresponding to a target gray scale;
the first polarity target data voltage is greater than a reference data voltage, the second polarity target data voltage is less than the reference data voltage, and an absolute value of a difference between the first polarity target data voltage and the reference data voltage is not equal to an absolute value of a difference between the second polarity target data voltage and the reference data voltage; and
the first sub-pixel and the second sub-pixel corresponding to the first polarity target data voltage and the second polarity target data voltage, respectively, or the same one of the plurality of sub-pixels corresponding to the first polarity target data voltage and the second polarity target data voltage, emit light to exhibit a target brightness corresponding to the target gray scale.

18. The electronic device of claim 17, wherein the same one or the different ones of the plurality of data lines is configured to first transmit a first sub-polarity target data voltage acting on the first sub-pixel and then transmit a second sub-polarity target data voltage acting on the second sub-pixel.

19. The electronic device of claim 17, further comprising:
a plurality of gate lines, wherein each of the gate lines is electrically connected to corresponding ones of the plurality of sub-pixels to transmit a corresponding gate signal, and the gate signal comprises a plurality of gate voltages configured to turn on corresponding ones of the plurality of sub-pixels;
wherein the plurality of gate voltages are greater than the first polarity target data voltage and the second polarity target data voltage, and the absolute value of the difference between the first polarity target data voltage and the reference data voltage is less than the absolute value of the difference between the first polarity target data voltage and the reference data voltage; or
the plurality of gate voltages are less than the first polarity target data voltage and the second polarity target data voltage, and the absolute value of the difference between the first polarity target data voltage and the reference data voltage is greater than the absolute value of the difference between the first polarity target data voltage and the reference data voltage.

20. The electronic device of claim 17, wherein a charging speed or a discharging speed at which the first polarity target data voltage is converted into the reference data voltage is not equal to a charging speed or a discharging speed at which the second polarity target data voltage is converted into the reference data voltage.
